(19) United States
(12) Patent Application Publication
(10) Pub. No.: US 2006/0037697 A1
(43) Pub. Date: Feb. 23, 2006

(54) Delabeling method, device for carrying out the same and use thereof

(75) Inventor: Fritz Brinkmann, Scheyern (DE)

Correspondence Address: JORDAN AND HAMBURG LLP, 122 EAST 42ND STREET, SUITE 4000, NEW YORK, NY, 10168, US

(73) Assignee: Nordenia Deutschland Pacimex GmbH, Scheyern (DE)

(21) Appl. No.: 10/514,002

(22) PCT Filed: Feb. 18, 2004
(86) PCT No.: PCT/EP04/01557

§ 371 Date: Jul. 1, 2005

(30) Foreign Application Priority Data
Mar. 10, 2003 (DE) 103 10 620.0
May 5, 2003 (DE) 103 20 089.4
Nov. 11, 2003 (DE) 203 17 472.0

(51) Int. Cl. B29C 63/00

(52) U.S. Cl. 156/344

(57) ABSTRACT

A method for separating or removing from a label carrier labels that adhere with a certain adhesive force to or on a label carrier, in particular to or on a bottle case, very particularly to or on a bottle or on the lateral surfaces of a bottle case, is known; it is distinguished in that for separating at least one stream of fluid is directed onto the area between label carrier and label.

The present invention relates to a method for separating or removing from a label carrier labels that adhere with a certain adhesive force to or on a label carrier, in particular to or on a bottle or a bottle case, very particularly to or on the lateral surfaces of a bottle case. In addition, it relates to an apparatus for performing this method and to its use.

Therefore, the present invention relates to a delabeling method for employment in areas and/or at sites at which labels are to be removed from any desired shape, e.g., rectangular or round label carriers; in general the present invention can thus be classified in the field of logistics. The method shall also apply to labels on bottles and so-called stretch-sleeves.

Such methods and apparatus are based on the fact that a mechanical separating or removing apparatus in the form of an abrasion device, a gripping device, or the like removes the labels adhering to or on the label carrier, in particular adhering to up to four lateral surfaces of a bottle crate.

In doing so, there is no way to prevent mechanical action upon the label carrier, rather than only on the label; since sharp and/or pointed instruments must frequently be employed for effectively and completely separating the label, damage and harm at least to the appearance of the surface of the label carrier is unavoidable.

In the exemplary instance of (lateral surfaces of) bottle crates as label carriers, the use of such a mechanical separating or removing apparatus leads not infrequently to damage such as scratches, splintering, and the like on the bottle crates, so that the latter are unusable or at least there is a risk of injury at the damaged sites after just a few cycles.

Furthermore, with the conventional methods and apparatus, the labels are not seldom only partially separated or removed from the label carrier, whether because the abrasion device, the gripping device, or the like only partially covered the label or because the mechanical force exerted by the label gripping device or the like starts to tear or even completely tears the label; consequently an unattractive old label remainder or a label remainder that interferes with or even interrupts a subsequent new labeling procedure remains on the label carrier, which is undesired under any circumstances.

Finally, with conventional mechanical separation and removal apparatus the disposal problem is still largely unsolved in that once they have been removed from the label carrier the labels generally flutter around unchecked and consequently are generally not accessible for proper disposal and environmentally-friendly recycling; this is no longer acceptable at this time, given how important environmental awareness has become.

Starting with the disadvantages and inadequacies described in the foregoing, the object of the present invention is to suggest a generic method in accordance with the preamble to the main claim and to suggest an apparatus and use such that labels can be removed reliably from label carriers in a simple manner.

This object is inventively achieved in a method in accordance with the preamble to the main claim using its characterizing features, i.e., in that for separating at least one stream of fluid is directed onto the area between label carrier and label.

Thus, in accordance with the invention, at least one stream of fluid (e.g., stream of water and/or compressed air) is directed onto the label and is preferably directed onto the edge of the label to be separated at an acute angle, advantageously in the range of between 5 and 45°.

The method is particularly successful when the stream of fluid is rotating (with a so-called rotor nozzle), whereby the rotating stream of fluid during its rotation describes an envelope of a cone, the tip of which is at the output of the (rotor) nozzle. In one useful embodiment of the invention, the pulsing and rotating can be combined with each stream of fluid or just with a portion of them.

Thus it is possible with the inventive method to separate labels from bottles or crates or stretch sleeves as label carriers in a reliable and simple manner. In addition, this method can be retrofitted to production lines.

Additional embodiments, features, and advantages of the present invention are characterized in the subordinate claims.

One preferred exemplary embodiment is described in detail in the following using the drawings.

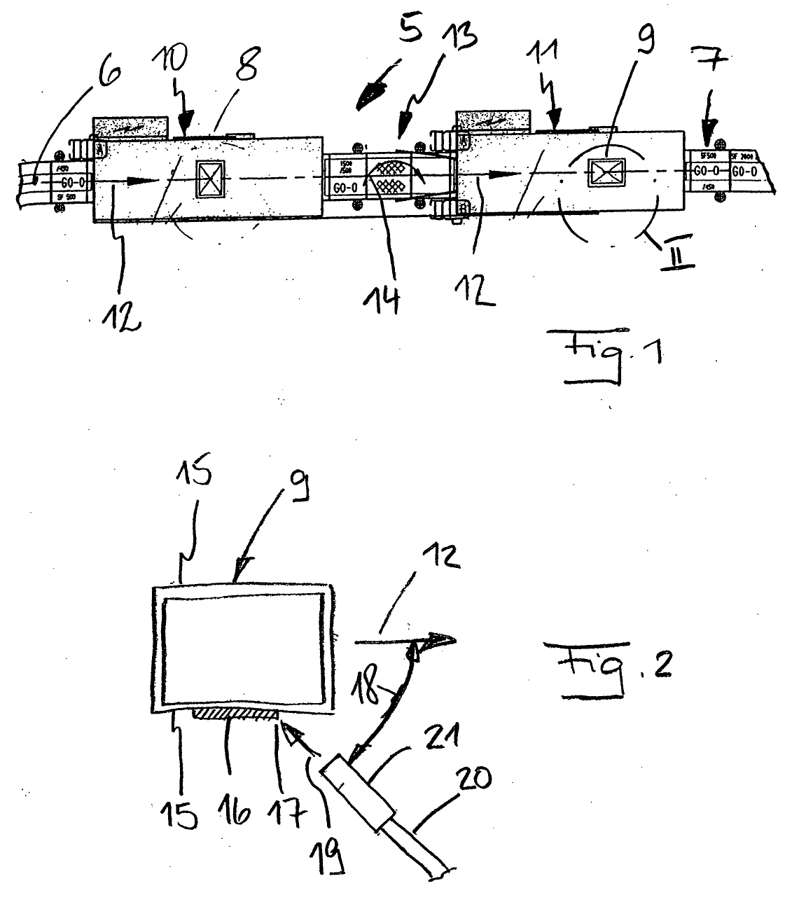

FIG. 1 is a top view of a system for delabeling bottle crates as label carriers

FIG. 2 is a detail II in accordance with FIG. 1.

The overall system labeled 5 in FIG. 1 has a transport line 7 that has a transport conveyor 6 upon which bottle crates 8, 9 are transported to the apparatus for delabeling 10, 11.

The labels are separated from the two lateral surfaces of the bottle crate 8. Then the bottle crate 8 is moved in accordance with the transport direction 12 to a rotating apparatus 13 that rotates (14) it about an axis perpendicular to its bottom and after rotating 90 degrees is moved further to the apparatus for delabeling 11, the principal details of which are illustrated in FIG. 2. There the labels (16) (shown only on one side) are separated from the two other lateral surfaces 15 of the bottle crate 8.

For this, a fluid pipe 20 with at least one nozzle 21 is provided for the stream of fluid, preferably a stream of water 19, which is directed at the area of the passing bottle crate 9 between it and the label 16 at an acute angle 18 in the range of 5° to 45° at label's edge 17.

The nozzle 21 is embodied rotating as a rotor nozzle for outputting a pulsing stream of water 19 that rotates about an envelope of a cone and/or as a pulsating nozzle for emitting a pulsing stream of water 19.

1. A method for separating from a label carrier, including lateral surfaces of bottle cases, adhered labels, the method comprising directing at least one stream of fluid onto an area between said label carrier and said label:

2. The method of claim 1, wherein said stream of fluid comprises a stream of water or compressed air.

3. The method of claim 1, wherein said stream of fluid is directed with high pressure onto an edge between said label and said label carrier.

4. The method of claim 1, wherein said stream of fluid is directed at an acute angle onto an edge between said label and said label carrier.

5. The method of claim 4, wherein said acute angle is in the range of 5 to 45°.

6. The method of claim 1, wherein at least a portion of said stream of fluid pulses or rotates.

7. The method of claim 6, wherein said rotating stream of fluid forms an envelope of a cone, a tip of said envelope being at the output of said nozzle.

8. The method of any one of claims 1 through 7, wherein said stream is produced by a fluid pipe, said pipe having at least one nozzle, said nozzle being directed toward said label carrier between said label carrier and said label.

9. The method of claim 8, wherein said nozzle of said fluid pipe is directed at an edge between said label and said label carrier.

10. (canceled)

11. The method of claim 9, wherein said nozzle of said fluid pipe is directed at an edge between said label and said label carrier at an acute angle in the range of 5 to 45°.

12. The method of claim 8, wherein said nozzle provides a pulsing stream of water.

13. The method of claim 8 comprising moving said label carrier on a transport line.

14. The method of claim 13, wherein said transport line has at least one transport conveyor.

15. The method of claim 8, comprising two adjacent transport apparatuses and a rotating apparatus, said rotating apparatus rotating said movable label carrier about an axis perpendicular to a bottom of said carrier, said rotating apparatus being provided between said adjacent transport apparatuses, said transport apparatuses being located in a transport direction of said label carrier.

16. (canceled)

17. The method of claim 5, wherein said acute angle is about 15°.
